(19) United States
(12) Patent Application Publication
(10) Pub. No.: US 2010/0206246 A1
(43) Pub. Date: Aug. 19, 2010

(54) Leash and spray dispenser

(76) Inventor: Dan Carl Waldrep, Dania Beach, FL (US)

Correspondence Address: Larry E Severin, Esq, 3581 Teaberry Circle, Seal Beach, CA, 90740, US

(21) Appl. No.: 12/706,432

(22) Filed: Feb. 16, 2010

Related U.S. Application Data
(60) Provisional application No. 61/152,856, filed on Feb. 16, 2009.

(51) Int. Cl. A01K 27/00; B67D 7/06; B65H 75/44; B65H 75/48

(52) U.S. Cl. 119/796; 222/192; 242/371; 242/381.6

(57) ABSTRACT

A retractable animal leash combined with a pepper spray dispenser includes: a housing having a first side and a second side; a handle at the first side of the housing; a dispenser region in the handle, adapted to retain the spray canister; and an attachment for the leash at the second side of the housing. A tube provides a path for spray from the spray canister to pass through the housing and out the second side of the housing. A trigger activates the spray canister and has a safety cover. A reel with a brake allows the leash to extend and urges the leash to retract.

### RELATED APPLICATIONS

This application claims the benefit of the filing date of U.S. Patent Application No. 61/152,856, filed Feb. 16, 2009, which is incorporated herein by reference in its entirety.

### BACKGROUND OF THE INVENTION

The present invention generally relates to safety devices and more specifically to a leash and spray dispenser.

Current retractable leash devices do not incorporate any safety or protective features. This puts the consumer at risk of injury from other animals or bystanders. When people walk their dogs using conventional retractable leashes, they have no protection from larger animals or dangerous people. If they choose to carry a pepper spray device, they must either use both hands or carry it out in the open by somehow attach it to the leash. This configuration can be cumbersome and difficult to operate in the case of an emergency.

It would be desirable to have a retractable animal leash combined with a pepper spray dispenser.

### SUMMARY OF THE INVENTION

In one aspect of the present invention, a device utilizing a spray canister and a leash includes: a housing having a first side and a second side; a handle at the first side of the housing; a dispenser region in the handle, adapted to retain the spray canister; and an attachment for the leash at the second side of the housing.

In another aspect of the present invention, a system for providing safety and holding a leash includes: a hollow handle, adapted to be held by a hand of a user and to retain a safety device that produces a spray, the safety device retained so as to be operable by the hand as the hand holds the handle; a retractable reel that allows the leash to extend away from the handle and retracts the leash into the reel; and a brake that allows the hand of the user to control the reel.

In yet another aspect of the present invention, a method for providing restraint and safety includes: holding a housing in a hand, the housing having a handle, a dispenser region in the handle, and a retractable reel; utilizing the retractable reel to extend and retract a leash; and utilizing the dispenser region to retain a safety device that produces a spray.

### BRIEF DESCRIPTION OF THE DRAWINGS

FIG. 1 depicts a side view of combination animal leash and pepper spray according to the present invention;

FIG. 2 depicts a perspective view of the embodiment of FIG. 1;

FIG. 3 depicts an example of a pepper spray canister utilized according to the embodiment of FIG. 1;

FIG. 4 depicts an embodiment of the handle cap of FIG. 1; and

FIG. 5 depicts an embodiment of the nozzle mechanism of FIG. 1.

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

An embodiment of the present invention generally provides a leash and spray dispenser. Embodiments may provide a combination retractable animal leash and pepper spray dispenser.

An embodiment of the present invention may provide a pepper spray or other spray dispenser integrated into the handle of the device, thus giving the consumer the use of a retractable leash with the addition of a safety feature. Since the spray dispenser is a built in feature, the consumer can conceal this self-defense device out of the view of the general public. This may provide the user with added protection without carrying any added equipment.

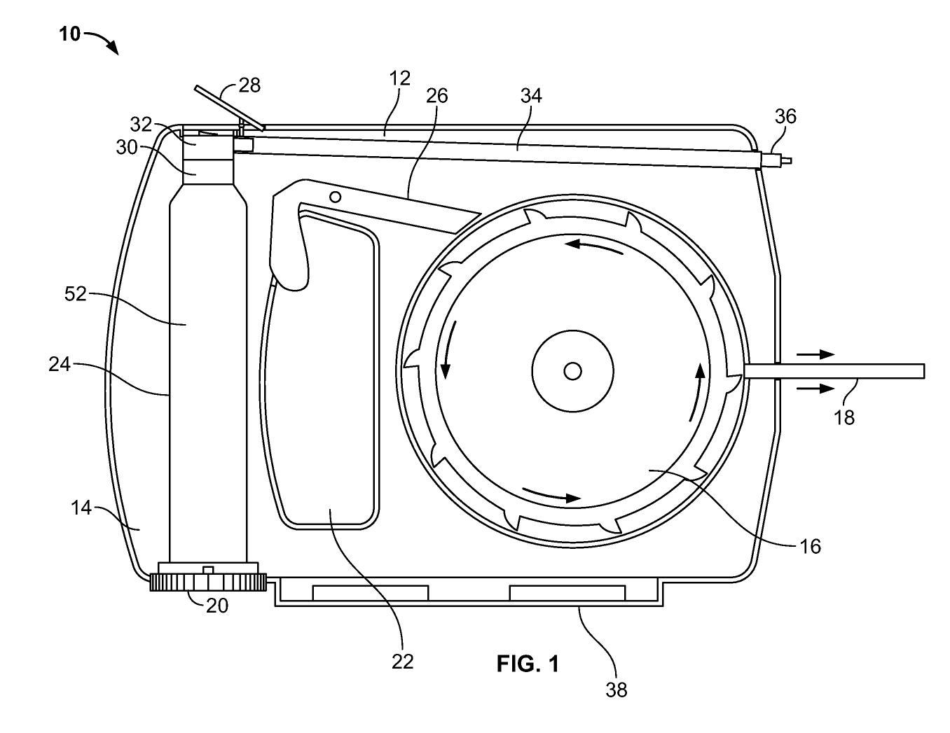

As depicted in FIG. 1, an embodiment of a combination retractable leash and pepper spray dispenser is a device 10 that may include a housing 12 that has a handle 14, a leash 18, and a dispenser region 24 or canister housing adapted to retain a pepper spray canister 52 or other safety device. The device 10 may include a retractable reel 16 and have a region in the housing 12 where the retractable reel 16 is retained, and a brake 26 or other control mechanism for controlling the reel 16 and leash 18. The device 10 may have a trigger 32 at one end of the dispenser region 24 that can be actuated by inserting the fingers in a handle opening 22 to hold the handle 14 and pressing down with a thumb on the trigger 32. The device 10 may include a safety cover 28 or other mechanism secured to the housing 12 to help cover the trigger 32 to prevent accidental discharge. A dispensing nozzle mechanism 30 may have a female threaded receptacle that releasably attaches to the canister 52 and connects the dispenser region 24 through the trigger 32 to a dispensing tube 34, which leads through the housing 12 to a dispensing spout 36 near the opposite side of the housing 12, so as to direct the pepper spray forward when the trigger 32 is actuated. A removable handle cap 20 may allow access to the dispenser region 24 so the canister 52 can be inserted or removed.

In an embodiment, the reel 16 may be generally circular and may be oriented to align with or be parallel with the handle 14, in that the main axis of the handle 14 is contained in the plane of the reel 16. The reel 16 may be a spring-loaded, retractable reel rotatably mounted in the housing 12, and may have the leash 18 connected thereto for extension from and retraction into the housing 12 through a leash aperture in the housing 12. The leash 18 may be a line or other restraining device, possibly for animals, that extends substantially in a forward direction from the housing 12, away from the handle 12. The pepper spray dispenser region 24 may house or contain a pepper spray canister 52 or other spray device or safety device so that the canister 52 sprays forward.

In an embodiment, the handle region 14 may be columnar and may be a hollow handle, adapted to contain pepper spray canister 52 and provide the user with access to the trigger 32, with a handle opening 22 area positioned between the handle 12 and the reel 16. The handle opening 22 may be an elongated opening extending transversely through the housing 12 for receiving the fingers of the user of the device 10. The handle 14, dispenser region 24, handle opening 22, and reel 16 may be substantially aligned or parallel with each other, and be approximately orthogonal to the forward direction of the leash 18. Dispensing tube 34 may be made of either a hard or soft plastic material and may be attached to the housing 12 in a way not to interfere with the reel 16. The dispensing spout 36 may be located in such a way that it sprays the pepper spray in the same direction that the animal leash extends. When the trigger 32 is depressed, the aerosol nozzle mechanism 40 of the canister 52 is activated, and the pepper spray is carried through the tube 34 thus dispensing the pepper spray at a desired target. Embodiments may include an accessory rail 38 on the bottom of the housing 12 to attach different accessories, such as a light, waste removal bag, etc.

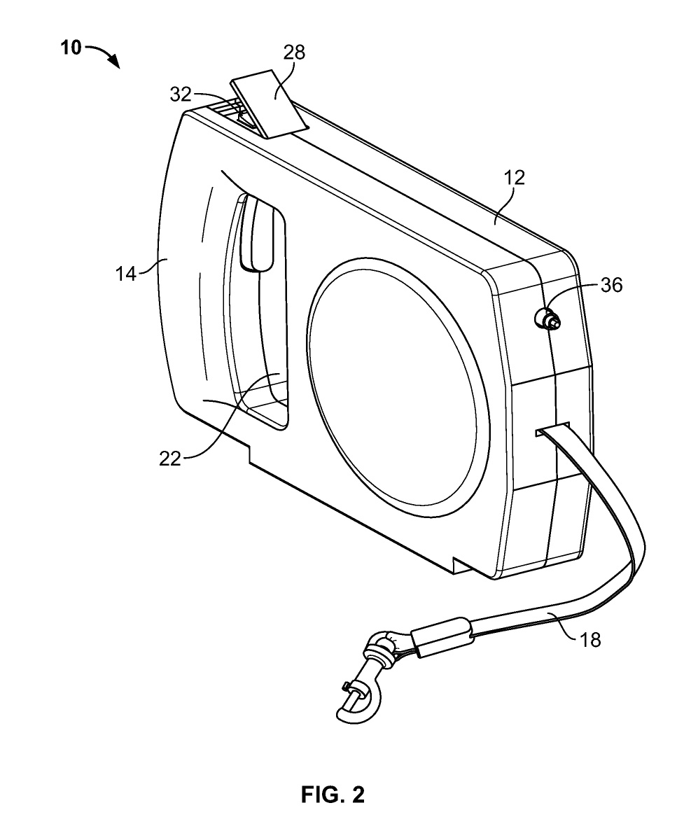

FIG. 2 depicts a perspective view of an embodiment of the present invention.

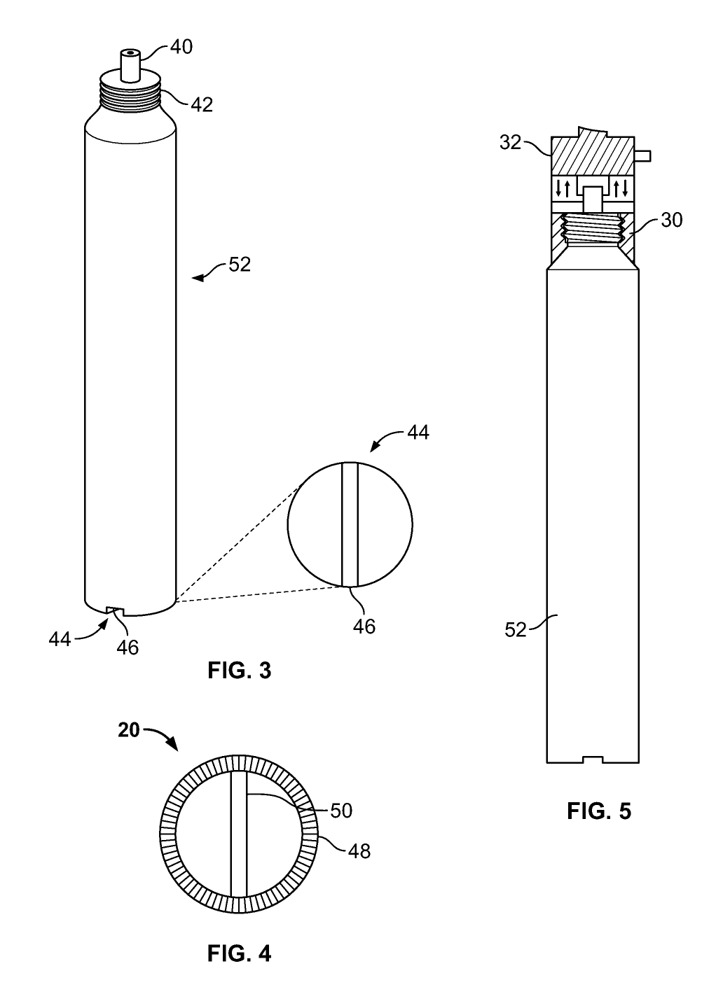

FIG. 3 depicts an example of a pepper spray canister, which may have an aerosol nozzle 40 that sits above a male threaded canister top 42. The bottom of the canister 44 has a depressed groove 46 or slot.

FIG. 4 depicts an embodiment of a removable handle cap 20 that has notches 48 around the rim, and a raised groove 50. Notches 48 help the user grip the cap, and the raised groove 50 aligns with the depressed groove 46 on the bottom of the canister 44 as depicted in FIG. 3, to help grip the canister 52 and screw it up into place so that the male canister top 42 mates with the male dispensing nozzle mechanism 30 depicted in FIG. 1.

FIG. 5 depicts a detailed view of the canister 52 fitting into the dispensing nozzle mechanism 30.

In an embodiment, the handle region of the retractable animal leash may encase the pepper spray dispenser mechanism. A round hollow orifice at the base of the hollow handle region may extend from top to bottom of the handle. This orifice may hold a cylindrical metal pressurized canister, which will contain a pepper spray chemical. The canister may be removable and replaceable, or the device could be formatted with a one-time use safety spray device, thus eliminating the need to remove the canister. The bottom of the cylinder may be grooved or slotted in the fashion of the head of a screw. This may allow the handle cap, slotted in the fashion of a screw driver, to grip the canister and screw it up into place when needed. The handle cap may be round in shape and have a coarse outer edge to make it easier to grip between the thumb and forefinger. When the cap is screwed into place it may allow the head of the cylinder to also thread itself into the nozzle mechanism. The housing of the nozzle mechanism may be built in to the handle. This connection may be achieved by making the head of the canister threaded in the male format. The nozzle mechanism may be threaded as well but in the female format, allowing it to receive the canister and seat itself into place when screwed in. As the canister seats itself into the nozzle mechanism it puts the canister in position ready for dispensing. A trigger may be placed just above the nozzle mechanism and protrude through the handle. The trigger may be a simple thumb depression trigger and may be protected by a retractable safety cover. This cover may lock over the trigger automatically, and may require the user to press down and pull back with their thumb to expose the trigger. The cover may be spring loaded, allowing it to open up and lift out of the way when needed. When the user or consumer depresses the trigger, it will compress the nozzle mechanism and release the pressurized contents of the canister.

In an embodiment, the control/brake device for the retractable reel could be located in the handle opening making it a forefinger trigger. The brake would be operated by pulling back on the trigger with the forefinger. When the trigger is pulled back and up with the forefinger, the brake assembly will pivot from a fixed point inside the housing region. This may cause the forward section of the brake assembly to move forward and down and seat itself inside grooves that may be placed on the retractable reel. When this happens, it will prevent the reel from rotating any further and stop the leash from extending. This brake assembly may be equipped with a spring so that after the trigger is compressed and released, it will return back to its original position. This assembly may be placed in such a way not to interfere with any other components of the invention. The device may include a leash on a reel, where the reel allows the leash to extend and urges the leash to retract, or may have another attachment mechanism for a leash to attach to the device.

In an embodiment, the trigger would be relocated from the top of the handle to the opening of the handle. This would then make the trigger a forefinger trigger rather than a thumb trigger. This could also apply to the placement of the control device/brake. Embodiments may be made in many sizes and styles. For example, a smaller version of the leash could be made for a smaller dog. Although all the components would be of a smaller size, they would all have the same features of the original product. An embodiment could be outfitted with a variety of different additional accessories or features, including, but not limited to, flashlights or plastic bag holders, which may be attached to a rail on the bottom of the leash housing. The placement of additional features could include the top, bottom, or sides of the housing, or additional features could also be built into the device itself. The placement of the pepper spray dispenser region could be relocated, based on the configuration of other components or options. For example, the pepper spray dispenser region could be located in the base, top, or sides of the housing region.

To use an embodiment, a user could hold the leash in one hand with the running end of the leash pointed out in front of him or her. The leash itself may be free running and self retracting, but can be controlled by way of a brake that is built into the handle region. The thumb or forefinger may be used to depress the brake, thus stopping the leash. While the user is operating the leash, the user has the option to activate the pepper spray dispenser. To accomplish this, the user depresses and pulls back on the safety cover with their thumb. This may be a small plastic cover located just behind the leash brake. The safety cover will flip up and out of the way exposing the trigger mechanism. The user may point the leash at its intended target and depress the trigger with their thumb. This will depress the trigger onto the canister, thus causing the pepper spray to travel through the tubing within the housing and exit through the spout located at the front of the housing. After the contents of the container have been emptied, the user then has the option to remove and replace the canister thus making the device ready to use again. To accomplish this, the user grips the handle cap between the thumb and forefinger and rotates it in a counterclockwise motion. This will unthread the canister and deactivate it for removal. The canister can be taken out from the bottom of the handle and discarded. To replace the canister the user reverses the process and the device will be ready to use once again.

Embodiments may be used against animals other than the dog being walked. In the case of the user being confronted by a larger or more aggressive animal, the pepper spray could be used against the animal.

I claim:

1. A device utilizing a spray canister and a leash, comprising:
a housing having a first side and a second side;
a handle at the first side of the housing;
a dispenser region in the handle, adapted to retain the spray canister; and
an attachment for the leash at the second side of the housing.

2. The device of claim 1, wherein the dispenser region retains the spray canister so that a user may hold the device utilizing the handle while operating the spray canister so as to spray toward the second side of the housing and away from the user.

3. The device of claim 1, further comprising:
a tube to provide a path for spray from the spray canister to pass through the housing and out the second side of the housing.

4. The device of claim, further comprising:
a spout at the second side of the housing to dispense spray from the spray canister away from the device.

5. The device of claim 1, further comprising:
a trigger to activate the spray canister;

6. The device of claim 5, further comprising:
a safety cover to releasably cover the trigger.

7. The device of claim 1, further comprising:
a reel adapted to allow the leash to extend and urge the leash to retract.

8. The device of claim 7, further comprising:
a brake to control the reel, positioned on the housing so that a user may hold the device utilizing the handle while operating the brake.

9. The device of claim 7, wherein the housing rotatably retains the reel so that the reel is aligned with the handle.

10. The device of claim 1, wherein the spray canister is a pepper spray canister.

11. The device of claim 1, further comprising:
a handle cap having a groove that matches with a notch in a bottom of the spray canister so as to help insert and retain the spray canister inside the dispenser region.

12. The device of claim 1, further comprising:
a first threaded receptacle in the dispenser region, adapted to mate with a second threaded receptacle on the spray canister, so that, when the spray canister is activated, the second threaded receptacle receives spray from the spray canister.

13. The device of claim 1, further comprising:
an accessory rail on the housing, adapted to retain an accessory.

14. A system for providing safety and holding a leash, comprising:
a hollow handle, adapted to be held by a hand of a user and to retain a safety device that produces a spray, the safety device retained so as to be operable by the hand as the hand holds the handle;
a retractable reel that allows the leash to extend away from the handle and retracts the leash into the reel; and
a brake that allows the hand of the user to control the reel.

15. The system of claim 14, further comprising:
a tube to direct the spray away from the user;

16. The system of claim 14, further comprising:
a trigger to activate the safety device.

17. The system of claim 14, further comprising:
a housing with a region for the retractable reel;
a tube to direct the spray away through the housing and away from the user;
a trigger on the housing that allows the hand of the user to activate the safety device; and
a retractable safety cover for the trigger.

18. The device of claim 17, wherein the safety device is a pepper spray canister having a nozzle and the trigger presses down on the nozzle to emit pepper spray from the canister, through the tube, and out of the housing.

19. A method for providing restraint and safety, comprising:
holding a housing in a hand, the housing having a handle, a dispenser region in the handle, and a retractable reel;
utilizing the retractable reel to extend and retract a leash; and
utilizing the dispenser region to retain a safety device that produces a spray.

20. The method of claim 19, further comprising:
a trigger to activate the safety device; and
an aperture in the housing to dispense spray from the safety device away from the housing.
